(19) United States
(12) Patent Application Publication
(10) Pub. No.: US 2018/0136709 A1
(43) Pub. Date: May 17, 2018

(54) Dynamic External Power Resource Selection

(71) Applicant: Microsoft Technology Licensing, LLC, Redmond, WA (US)

(72) Inventors: Aniruddha Jayant Jahagirdar, Bellevue, WA (US); Ranveer Chandra, Kirkland, WA (US); James Anthony Schwartz, JR., Seattle, WA (US); Paresh Maisuria, Issaquah, WA (US); Matthew Holle, Kirkland, WA (US); M. Nashaat Soliman, Redmond, WA (US); Aacer Hatem Daken, Renton, WA (US)

(73) Assignee: Microsoft Technology Licensing, LLC, Redmond, WA (US)

(21) Appl. No.: 15/353,548

(22) Filed: Nov. 16, 2016

(51) Int. Cl. G06F 1/32; G06F 1/20; G06F 1/26; H02J 7/00

(52) U.S. Cl. CPC G06F 1/3212; H02J 7/0055; G06F 1/263; G06F 1/206

(57) ABSTRACT

A computing device has an energy storage device system with one or more energy storage devices. The computing device can be connected to various different power resources (e.g., power sources and/or power profiles) to charge the energy storage device(s). Various different criteria are used to determine which one or more of the power resources to use at any given time to charge the energy storage device(s). The criteria can include physical characteristics of the computing device, characteristics of the energy storage devices and/or the computing device that change while the computing device operates, and estimated or predicted usage of the computing device. These criteria are evaluated during operation of the computing device, and the appropriate power resources to charge the energy storage device(s) at any given time based on these criteria are determined.

### BACKGROUND

As technology has advanced, mobile computing devices have become increasingly commonplace. Mobile computing devices provide various functionality to users, allowing the user to interact with the device to check email, surf the web, compose text messages, interact with applications, and so on. One challenge that faces developers of mobile computing devices is efficient power management and extension of battery life. If power management implemented for a device fails to provide a good battery life, user dissatisfaction with the device and manufacturer may result.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

In accordance with one or more aspects, in a computing device having an energy storage device system including one or more energy storage devices, multiple power resources available to the computing device to charge a first energy storage device of the one or more energy storage devices are identified. A first power resource of the multiple power resources that is most energy efficient for the first energy storage device is selected, and the energy storage device system is configured to charge the first energy storage device using the first power resource.

In accordance with one or more aspects, in a computing device having an energy storage device system including one or more energy storage devices, multiple power resources available to the computing device to charge a first energy storage device of the one or more energy storage devices are identified. For each of the multiple power resources, thermal activity along a charging path from the power resource to the first energy storage device is determined. A power resource of the multiple power resources based on the thermal activity along the charging paths from the multiple power resources to the first energy storage device is selected, and the energy storage device system is configured to charge the first energy storage device using the selected power source.

In accordance with one or more aspects, a computing device includes an energy storage device system including one or more energy storage devices, a processing system, and a computer-readable storage medium. The computer-readable storage medium has stored thereon multiple instructions that, responsive to execution by the processing system, cause the one or more processors to perform operations comprising: determining that an amount of charge in the one or more energy storage devices is below a threshold amount of charge, determining that the computing device is predicted to be connected to a power resource for less than a threshold amount of time, and thermally conditioning the computing device, prior to the computing device being connected to the power resource, to reduce a temperature of the computing device.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items. Entities represented in the figures may be indicative of one or more entities and thus reference may be made interchangeably to single or plural forms of the entities in the discussion

FIG. 1 illustrates an operating environment in accordance with one or more embodiments.

FIG. 2 depicts example details of a computing device having an energy storage device system with one or more energy storage devices in accordance with one or more implementations.

FIG. 3 is a flow diagram that describes details of an example procedure for dynamic external power resource selection in accordance with one or more implementations.

FIG. 4 is a flow diagram that describes details of another example procedure for dynamic external power resource selection in accordance with one or more implementations.

FIG. 5 illustrates an example system that includes an example computing device that is representative of one or more computing systems and/or devices that may implement the various techniques described herein.

### DETAILED DESCRIPTION

Overview

Dynamic external power resource selection is described for a computing device having an energy storage device system with one or more energy storage devices. The energy storage devices can be charged by a variety of different power resources that can be connected to the computing device. A power resource refers to a power source and/or a power profile. A power source is a source of power, typically AC power, that can be used to charge the one or more energy storage devices of the computing device. A power profile refers to an amount of power that is provided by a power source. A power resource can support one or multiple different power profiles.

Various different criteria are used to determine which one or more of the multiple power resources to use to charge the energy storage devices at any given time. The criteria used to determine which one or more of the multiple power resources to use at any given time to charge the energy storage devices include static criteria, dynamic system criteria, and prediction criteria. The static criteria refers to physical characteristics of the energy storage devices and/or computing device that do not change while the computing device operates (e.g., while executing different programs). The dynamic system criteria refers to characteristics of the energy storage devices and/or the computing device that change while the computing device operates (e.g., while executing different programs). The prediction criteria refers to estimated or predicted user behavior (e.g., predicting the intent of the user), program behavior (e.g., predicting how the software installed is using/causing usage of the system, such as an antivirus service), and/or more general usage of the computing device, such as connection to a power resource.

These criteria are evaluated during operation of the computing device, and the appropriate power resources from which to draw power at any given time to charge the energy storage devices of the computing device are determined based on these criteria. The techniques discussed herein allow power to be drawn from the different power resources to charge the energy storage devices of the computing device in a manner that accommodates the particular computing device as well as the user's typical use of the computing device. Smarter decisions can be made regarding when to charge the energy storage devices and which power resources to draw power from, which can allow the computing device to be run on energy storage device power for a longer duration of time and can extend the lifespan of the energy storage devices.

In the discussion that follows, a section titled “Operating Environment” is provided and describes one example environment in which one or more implementations can be employed. Following this, a section titled “Dynamic External Power Resource Selection System Details” describes example details and procedures in accordance with one or more implementations. Last, a section titled “Example System” describes example computing systems, components, and devices that can be utilized for one or more implementations of dynamic external power resource selection.

Operating Environment

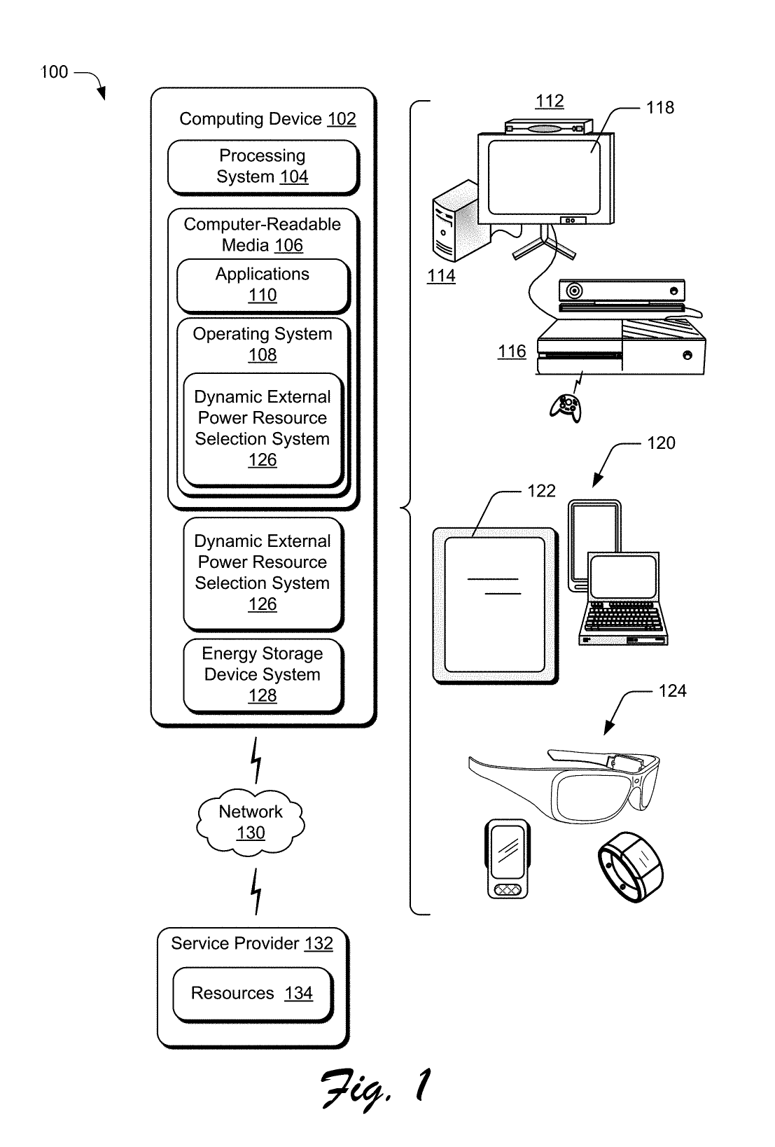

FIG. 1 illustrates an operating environment in accordance with one or more embodiments, generally at 100. The environment 100 includes a computing device 102 having a processing system 104 with one or more processors and devices (e.g., CPUs, GPUs, microcontrollers, hardware elements, fixed logic devices, etc.), one or more computer-readable media 106, an operating system 108, and optionally one or more applications 110 that reside on the computer-readable media and which are executable by the processing system. The processing system 104 may be configured to include multiple independent processors configured in parallel or in series and one or more multi-core processing units. A multi-core processing unit may have two or more processors (“cores”) included on the same chip or integrated circuit. In one or more implementations, the processing system 104 may include multiple processing cores that provide a range of performance capabilities, processing efficiencies, and power usage characteristics.

The processing system 104 may retrieve and execute computer-program instructions from applications 110 to provide a wide range of functionality to the computing device 102, including but not limited to gaming, office productivity, email, media management, printing, networking, web-browsing, and so forth. A variety of data and program files related to the applications 110 can also be included, examples of which include games files, office documents, multimedia files, emails, data files, web pages, user profile and/or preference data, and so forth.

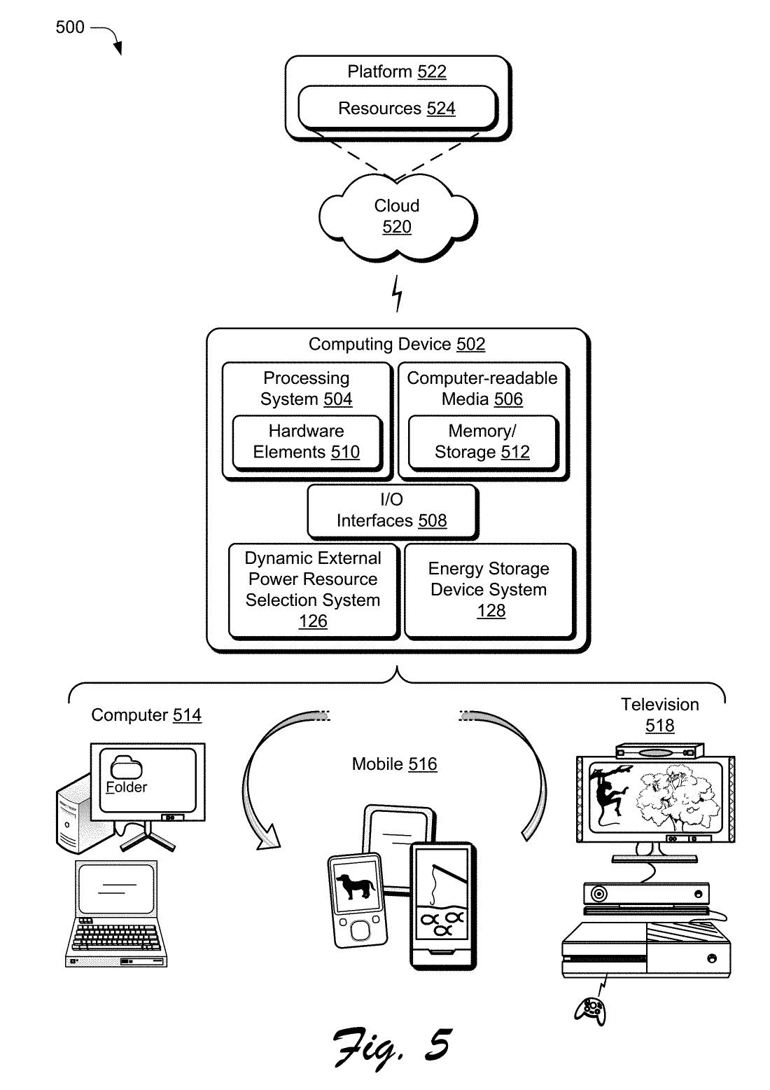

The computing device 102 can be embodied as any suitable computing system and/or device such as, by way of example and not limitation, a gaming system, a desktop computer, a rack server or other server computer, a portable computer, a tablet or slate computer, a handheld computer such as a personal digital assistant (PDA), a cell phone, a set-top box, a wearable device (e.g., watch, band, glasses, virtual reality (VR) headsets, augmented reality (AR) headsets, etc.), a home computing device (e.g., a voice-controlled wireless speaker or other smart-home device), an enterprise commodity device (e.g., an automated teller machine (ATM)), other consumer devices (e.g., drones, smart clothing, etc.), and so forth. For example, as shown in FIG. 1 the computing device 102 can be implemented as a television client device 112, a computer 114, and/or a gaming system 116 that is connected to a display device 118 to display media content. Alternatively, the computing device may be any type of portable computer, mobile phone, or portable device 120 that includes an integrated display 122. A computing device may also be configured as a wearable device 124 that is designed to be worn by, attached to, carried by, or otherwise transported by a user. Examples of wearable devices 124 depicted in FIG. 1 include glasses, headsets, a smart band or watch, and a pod device such as clip-on fitness device, media player, or tracker. Other examples of wearable devices 124 include but are not limited to badges, a key fob, an access card, and a ring, an article of clothing, a glove, or a bracelet, to name a few examples. Any of the computing devices can be implemented with various components, such as one or more processors and memory devices, as well as with any combination of differing components. One example of a computing system that can represent various systems and/or devices including the computing device 102 is shown and described below in relation to FIG. 5.

The computer-readable media can include, by way of example and not limitation, all forms of volatile and non-volatile memory and/or storage media that are typically associated with a computing device. Such media can include ROM, RAM, flash memory, hard disk, removable media and the like. Computer-readable media can include both “computer-readable storage media” and “communication media,” examples of which can be found in the discussion of the example computing system of FIG. 5.

The computing device 102 also includes a dynamic external power resource selection system 126 and an energy storage device system 128 that operate as described above and below. The dynamic external power resource selection system 126 can be implemented as part of the operating system 108, can be implemented as separate from the operating system 108, or can be implemented in part by the operating system 108 and in part separate from the operating system 108. The dynamic external power resource selection system 126 can optionally be implemented as one or more discreet systems 126 working in concert. The energy storage device system 128 is configured to include one or more energy storage devices as discussed in greater detail below. The dynamic external power resource selection system 126 and energy storage device system 128 may be provided using any suitable combination of hardware, software, firmware, and/or logic devices. As illustrated, the dynamic external power resource selection system 126 and energy storage device system 128 may be configured as separate, standalone systems. In addition or alternatively, the dynamic external power resource selection system 126 may also be configured as a system or module that is combined with the operating system 108 or implemented via a controller or other component of the energy storage device system 128.

The dynamic external power resource selection system 126 represents functionality operable to manage charging of the energy storage devices of the energy storage device system 128, including selecting power resources to charge energy storage devices of the energy storage device system 128, allowing selection of different power resources for charging the energy storage devices at different times. This may involve analyzing various criteria including static criteria for the computing device 102, dynamic system criteria for the computing device 102, and usage prediction for the computing device 102. The static criteria, in contrast to the dynamic system criteria for the computing device 102, do not typically change while the computing device 102 operates. The static criteria for the computing device 102 refers to physical characteristics of (such as the locations of hardware in) the computing device 102, characteristics of static software and/or firmware, static properties such as interconnect resistance or thermal zone layout (e.g., which devices are in which thermal zones) as discussed in more detail below, and so forth. The dynamic system criteria for the computing device 102 refers to characteristics of the energy storage devices that are part of the energy storage device system 128 and/or the computing device 102 that change while the computing device 102 operates (e.g., runs the operating system 108 and one or more applications 110). The prediction criteria for the computing device 102 refers to estimated or predicted user behavior, program behavior, and/or more general usage of the computing device 102, such as connection of the computing device 102 to a power resource.

The dynamic external power resource selection system 126 can manage charging the energy storage devices by controlling modes of the energy storage device system 128, states of battery cells or other energy storage devices of the energy storage device system 128, routing of power from power resources to the energy storage device system 128, and so forth. For example, the dynamic external power resource selection system 126 is operable to communicate control signals or otherwise interact with the energy storage device system 128 to direct operation of switching hardware to switch between energy storage devices to provide charging current to energy storage devices of the energy storage device system 128 in accordance with the analysis performed by the dynamic external power resource selection system 126. Details regarding these and other aspects of dynamic external power resource selection are discussed in the following section.

The environment 100 further depicts that the computing device 102 may be communicatively coupled via a network 130 to a service provider 132, which enables the computing device 102 to access and interact with various resources 134 made available by the service provider 132. The resources 134 can include any suitable combination of content and/or services typically made available over a network by one or more service providers. For instance, content can include various combinations of text, video, ads, audio, multi-media streams, applications, animations, images, webpages, and the like. Some examples of services include, but are not limited to, an online computing service (e.g., “cloud” computing), an authentication service, web-based applications, a file storage and collaboration service, a search service, messaging services such as email and/or instant messaging, and a social networking service.

Having described an example operating environment, consider now example details and techniques associated with one or more implementations of dynamic external power resource selection.

Dynamic External Power Resource Selection System Details

To further illustrate, consider the discussion in this section of example devices, components, procedures, and implementation details that may be utilized to provide dynamic external power resource selection as described herein. In general, functionality, features, and concepts described in relation to the examples above and below may be employed in the context of the example procedures described in this section. Further, functionality, features, and concepts described in relation to different figures and examples in this document may be interchanged among one another and are not limited to implementation in the context of a particular figure or procedure. Moreover, blocks associated with different representative procedures and corresponding figures herein may be applied together and/or combined in different ways. Thus, individual functionality, features, and concepts described in relation to different example environments, devices, components, figures, and procedures herein may be used in any suitable combinations and are not limited to the particular combinations represented by the enumerated examples in this description.

### Example Device

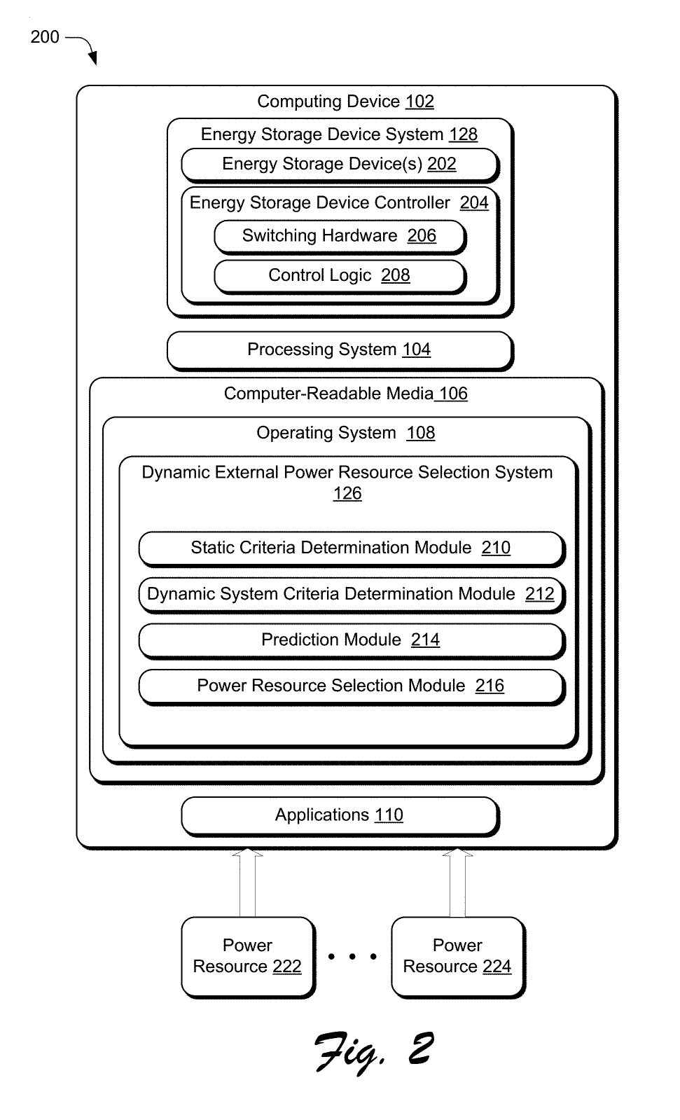

FIG. 2 depicts generally at 200 example details of a computing device 102 having an energy storage device system 128 with one or more energy storage devices in accordance with one or more implementations. Computing device 102 also includes processing system 104, computer readable media 106, operating system 108 and applications 110 as discussed in relation to FIG. 1. In the depicted example, a dynamic external power resource selection system 126 is also shown as being implemented as a component of the operating system 108. It should be noted, however, that the dynamic external power resource selection system 126 can alternatively be implemented in other manners. For example, parts of (or all of) the dynamic external power resource selection system 126 can be implemented as part of the energy storage device system 128.

By way of example and not limitation, the energy storage device system 128 is depicted as having one or more energy storage devices 202 and an energy storage device controller 204. The energy storage device(s) 202 are representative of various different kinds of energy storage devices that may be included and/or compatible with the computing device 102. These energy storage devices can include, for example, individual or a collection of battery cells, supercapacitors, and so forth. Energy storage devices 202 can include energy storage devices that are designed to be included in and specifically work with the computing device 102 at the time of manufacture or distribution, and/or external energy storage devices (e.g., original equipment manufacturer (OEM) manufactured external batteries) that are added to the computing device 102 (e.g., by the user) at a later point in time. It should be noted that these energy storage devices include various devices that store energy as opposed to being an external AC power resource. Energy storage device(s) 202 can include a single energy storage device, or alternatively multiple energy storage devices having different characteristics such as different sizes, capacities, chemistries, battery technologies, shapes, age, cycles, temperature, and so forth (heterogeneous energy storage devices). Accordingly, the energy storage device system 128 can optionally include a diverse combination of multiple energy storage devices at least some of which can have different characteristics one to another. Alternatively, the energy storage device(s) 202 can include energy storage devices having the same characteristics, or a single energy storage device. Various combinations of energy storage device(s) 202 may be utilized to provide a range of capacities, performance capabilities, efficiencies, power usage characteristics, and utilization of space in the device (e.g., for the purpose of balancing the weight, increasing energy storage capacity and/or energy storage characteristics), and so forth.

The energy storage device controller 204 is representative of a control system to control operation of the energy storage device system 128, to control delivery of power from the energy storage device(s) 202 to service a system load of the computing device 102, and to control delivery of power from one or more power resources 222, 224 to the energy storage device(s) 202 to charge the energy storage device(s) 202. The system load refers to the energy required by the computing device 102 at any given point in time in order to operate. The energy storage device controller 204 may be configured using various logic, hardware, circuitry, firmware, and/or software suitable to connect the energy storage device(s) 202 one to another, supply power to the system, switch between the energy storage devices, and so forth. By way of example and not limitation, the energy storage device controller 204 in FIG. 2 is depicted as including switching hardware 206 and control logic 208 that is operable to selectively switch between use of different designated sources of the energy storage device(s) 202 at different times. Control logic 208 may reflect different switching modes that switch between charging different ones of the energy storage device(s) 202 so that power is provided to ones of the energy storage device(s) 202 based on various criteria as determined by the dynamic external power resource selection system 126. Thus, rather than merely interconnecting energy storage devices in parallel or series, switching hardware 206 can be utilized to set-up a switching scheme to select different energy storage devices based on different criteria for the computing device 102.

The computing device 102 can be connected to various different power resources 222, 224. Although two power resources 222, 224 are shown in FIG. 2, the computing device 102 can be connected to any number of power resources. As discussed previously, a power resource refers to a power source and/or a power profile. A power source is a source of power, typically AC power, that can be connected to the computing device 102. A power source can be connected to the computing device 102 via a wired connection and/or a wireless connection. For a wired connection, the computing device 102 can provide various different power ports that can receive charging power from a power source. These power ports can be proprietary ports, or conform to various standards (e.g., a Universal Serial Bus (USB) port). A power profile refers to an amount of power that is provided by a power source. A power source can support one or multiple different power profiles. For example, a power source can support both a normal power profile that provides less power (e.g., a low voltage) and a rapid charging power profile that provides more power (e.g., a higher voltage than the normal power profile provides).

The power resources 222, 224 are external to the computing device 102. The power resources 222, 224 are separate from the energy storage devices 202 and are used to charge the energy storage devices 202.

It should be noted that although reference is made herein to an AC (Alternating Current) power source, DC (Direct Current) power is drawn from that power source (e.g., the AC power source). Furthermore, in some cases power is drawn in other manners, such as a wireless power source that transmits power as magnetized waves. The techniques discussed herein apply regardless of the nature of the power sources.

The dynamic external power resource selection system 126 includes a static criteria determination module 210, a dynamic system criteria determination module 212, a prediction module 214, and a power resource selection module 216.

The static criteria determination module 210 represents functionality operable to determine values for various characteristics of the components included in and/or other physical characteristics of (such as the locations of hardware included in) the computing device 102, characteristics of static software and/or firmware, static properties such as interconnect resistance or thermal zone layout (e.g., which devices are in which thermal zones) as discussed in more detail below, and so forth.

In one or more embodiments, the static criteria includes an indication of proximity of power resources 222, 224 to the energy storage device(s) 202 in the computing device 102. The proximity of a power resource to an energy storage device refers to the electrical proximity between the power resource and the energy storage device. The proximity of a power resource to an energy storage device can be specified using various different values. In one or more embodiments, the proximity of a power resource to an energy storage device is specified by a value that represents the interconnect resistance between the power resource and the energy storage device. The interconnect resistance is a measure of the amount of resistance between a power resource and an energy storage device, and typically increases as the physical distance between the power resource and the energy storage device increases. Larger amounts of interconnect resistance result in larger amounts of power loss between the power resource and the energy storage device. Additionally or alternatively, the proximity of a power resource to an energy storage device is specified by a value that is the physical distance from the power resource to the energy storage device (e.g., as measured in centimeters or inches).

A different value representing the proximity of a power resource to an energy storage device is obtained for each power resource and energy storage device pair. The values representing the proximity of a power resource to an energy storage device can be obtained in a variety of different manners, such as from the supplier or manufacturer of the computing device 102, based on observations of charging the energy storage device using the power resource (e.g., by the operating system 108 and/or dynamic external power resource selection system 126), and so forth.

The power resource selection module 216 can use the values representing the proximity of power resources to energy storage devices in various different manners. It should be noted that, although illustrated separately in FIG. 2, at least part of the power resource selection module 216 can be implemented as part of the energy storage device 128. In situations in which the energy storage device 128 implements part of the power resource selection module 216, part of the dynamic external power resource selection system 126 that is manifested in the operating system 108 is responsible for dictating policies (e.g., mode selection and energy storage device constraints settings) to the part of the dynamic external power resource selection system 126 manifested in the energy storage device 128

In one or more embodiments, the power resource selection module 216 selects, to charge an energy storage device, a power resource that is most energy efficient for that energy storage device. For example, for a given energy storage device, the power resource selection module 216 can select as the most efficient energy storage device to charge the energy storage device the power resource having the smallest interconnect resistance to the energy storage device and/or the power resource having the smallest physical distance to the energy storage device.

In situations in which the energy storage device system 128 includes multiple energy storage devices 202, the power resource selection module 216 can use the values representing the proximity of power resources to energy storage devices to charge multiple energy storage devices 202 concurrently. In one or more embodiments, the power resource selection module 216 selects, for each of multiple energy storage devices, a power resource that is most energy efficient for that energy storage device to charge the energy storage device. For example, if the energy storage device system 128 includes two energy storage devices, energy storage device A and energy storage device B, the power resource selection module 216 can select to charge energy storage device A by a power resource X having the smallest interconnect resistance to the energy storage device A, and to charge energy storage device B by a power resource Y having the smallest interconnect resistance to the energy storage device B.

The dynamic system criteria determination module 212 represents functionality operable to determine values for various characteristics of the energy storage device(s) 202, the computing device 102, and/or the power resources 222, 224 that changes while the computing device 102 operates (e.g., while the computing device 102 runs the operating system 108 and one or more applications 110). The criteria used by the dynamic system criteria determination module 212 are referred to as dynamic because they change over time during operation of the computing device 102. For example, the criteria used by the dynamic system criteria determination module 212 can include the temperature of a thermal zone of a charging path from a power resource to an energy storage device, which changes over time during operation of the computing device 102, the ages of the energy storage devices 202, and so forth.

In one or more embodiments, the dynamic system criteria involve different thermal zones. A thermal zone refers to a group of one or more components (e.g., hardware) that are treated collectively for purposes of temperature control. Different thermal zones can optionally have different cooling mechanisms, such as vents, fans, heat sinks, and so forth. The dynamic external power resource selection system 126 can obtain an indication of which components are in which thermal zones in various manners, such as from the supplier or manufacturer of the computing device 102. In one or more embodiments in which the computing device 102 supports the Advanced Configuration and Power Interface (ACPI) Specification, such as the Advanced Configuration and Power Interface Specification, Version 6.1 (January, 2016), the dynamic external power resource selection system 126 can obtain an indication of the thermal zones, and optionally which components are in which thermal zones, by invoking methods of the ACPI.

The charging path from a power resource to an energy storage device includes multiple components: the power resource, the energy storage device, and optionally one or more additional components that the power passes through when being routed from the power resource to the energy storage device. Each of the components in the charging path can be included in the same thermal zone, or alternatively different components of the charging path can be included in different thermal zones. The power resource selection module 216 can select power resources to draw power from to charge energy storage device(s) 202 based on thermal activity along these charging paths.

In one or more embodiments, the dynamic system criteria includes an indication, for each pair of power resource and energy storage device, of whether the charging path between the power resource and the energy storage device is in a thermally hot (also referred to as thermally active) zone. The dynamic system criteria determination module 212 can obtain indications of temperatures of the different thermal zones in various manners, such as via the ACPI, by accessing temperature gauge components in the computing device 102, and so forth. A thermal zone is referred to as a hot zone or a thermally hot zone if the temperature of the thermal zone satisfies (e.g., is the same as, is the same as or equal to) a threshold temperature. In one or more embodiments, the threshold temperature is a value above which the designer or supplier of the computing device 102 prefers that the thermal zone not run. The threshold temperature can be, for example, a particular temperature (e.g., 85 degrees Fahrenheit), or a relative value (e.g., 80% of a maximum operating temperature of the computing device 102 as specified by the designer or supplier of the computing device 102).

A value for each charging path can be generated based on whether the charging path is in a thermally hot zone. For example, a value of 1 or True can be used to indicate that the charging path includes one or more components in a thermally hot zone, and thus that the charging path is in a thermally hot zone. A value of 0 or False can be used to indicate that the charging path includes no components in a thermally hot zone (which may also be referred to as a thermally stable zone), and thus that the charging path is not in a thermally hot zone.

The power resource selection module 216 can use the values indicating which charging paths are in a thermally hot zone and which charging paths are not in a thermally hot zone in various different manners. In one or more embodiments, the power resource selection module 216 selects a charging path that is not in a thermally hot zone (also referred to as being in a thermally stable zone), and configures the energy storage devices 128 to charge the energy storage device using the power resource from the selected charging path. The temperatures of components in the charging path typically increase as current is provided to the energy storage device, and by selecting a charging path that includes no components in a thermally hot zone the dynamic external power resource selection system 126 facilitates managing thermal stability of the computing device 102 (e.g., keeping a thermal zone of the computing device 102 from getting too hot) when selecting which power resource to use to charge an energy storage device.

In situations in which there are multiple power resources connected to the computing device 102 that can be used to charge the energy storage device(s) 202. In such situations, a single power resource can be used to provide power to charge an energy storage device 202. Alternatively, such as in situations in which all charging paths to an energy storage device to be charged include a component in a thermally hot zone, the power used to charge the energy storage device can be provided by multiple different power resources. The different power resources can be duty cycled, with different ones of the power resources providing the power used to charge the energy storage device at different times.

In one or more embodiments, the dynamic system criteria includes an indication of which power resources are connected to the computing device 102 and can be used to charge the energy storage device(s) 202 at any given time. A value for each power resource is determined. Different integers (e.g., 1, 2, 3, etc.) or other labels can be used as the value for each power resource. Alternatively, a value for each power resource can be generated based on, for example, how recently or some duration that current has been provided by the power resource to an energy storage device for charging. This value can take various forms, such as a number of milliseconds, one value (e.g., 1 or True) to indicate that current has recently been provided by the power resource and another value (e.g., 0 or False) to indicate that current has not recently been provided by the power resource, and so forth.

The power resource selection module 216 can use the values indicating the different power resources in various different manners. In one or more embodiments, the power resource selection module 216 uses the values to select a power resource, duty cycling the multiple power resources (e.g., duty cycling power source and/or power profiles). The temperature of components in a charging path typically increases as current is provided to the energy storage device for charging, so by duty cycling the power resources different charging paths are used and the increase in heat as a result of charging the energy storage devices is spread across the components in the different charging paths. For example, if there are three power resources, the power resource selection module 216 selects a first of the three power resources for charging the energy storage device for a particular amount of time (e.g., 5 seconds), then selects a second of the three power resources for charging the energy storage device for a particular amount of time (e.g., 5 seconds), then selects a third of the three power resources for charging the energy storage device for a particular amount of time (e.g., 5 seconds), then selects the first of the three power resources for charging the energy storage device for a particular amount of time (e.g., 5 seconds), and so forth.

The power resource selection module 216 can additionally or alternatively select power resources to draw power from to charge energy storage device(s) 202 based on other thermal activity along the charging paths. In one or more embodiments, the power resource selection module 216 starts and stops charging of an energy storage device based on performance of the computing device 102. The performance of the computing device 102 can be measured in a variety of different manners, such as the performance of a central processing unit (e.g., a speed or utilization of the central processing unit), the performance of graphics processing unit (e.g., a speed or utilization of the graphics processing unit), the amount of memory load or usage in the computing device 102, and so forth. If the computing device 102 is in a high performance state (e.g., a graphics or central processing unit is running at a threshold frequency or higher (e.g., 1.2 gigahertz), a graphics or central processing unit is running at a threshold utilization or higher (e.g., 50% utilization), etc.) and mitigation of thermal activity is desired (e.g., due to the current thermal activity), then the power resource selection module 216 stops charging the energy storage device. This alleviates any increase in temperature of the energy storage device (and the charging path to the energy storage device) due to charging of the energy storage device, and prioritizes computing device performance over energy storage device charging when the computing device is operating in a high performance state.

However, if the computing device 102 is not in a high (e.g., the highest) performance state (e.g., a graphics or central processing unit is running at less than a threshold frequency (e.g., 1.2 gigahertz), a graphics or central processing unit is running at less than a threshold utilization (e.g., 50% utilization), etc.), then the power resource selection module 216 starts or resumes charging the energy storage device. This prioritizes energy storage device charging over computing device performance when the computing device is operating in a low performance state.

Additionally or alternatively, the power resource selection module 216 can duty cycle charging and throttling of performance states. Throttling performance states refers to reducing the performance of hardware and/or software components. Reducing the performance of a hardware component refers to reducing the amount of heat generated by the component, typically by running the hardware component at a slower frequency or rate. For example, the performance of a processing unit can be reduced by slowing the frequency at which the processing unit runs (e.g., from 1.2 gigahertz (GHz) to 800 megahertz (MHz)). Reducing the performance of software components can be done in various manners, such as by limiting performance, by putting resource constraints and/or budget on the software (currently in operation or due to run in the future), by means of suspending operation (by means of postponing running of software or cancelling it all together), combinations thereof, and so forth.

By duty cycling charging and throttling of performance states, the power resource selection module 216 alternates between charging the energy storage devices and running the hardware and/or software components in a high performance state. By not charging the energy storage devices at the same time as the hardware and/or software components are run in a high performance state, the amount of heat in the computing device 102 is reduced.

The prediction module 214 represents functionality operable to determine values for various characteristics of estimated or predicted user behavior (e.g., predicting the intent of the user), program behavior (e.g., predicting how the software installed is using/causing usage of the system, such as an antivirus service), and/or more general usage of the computing device 102. This predicted behavior or usage can include, for example, timing of connection of the computing device 102 to a power resource, duration of connection of the computing device 102 to a power resource, power profile(s), combinations thereof, and so forth.

In one or more embodiments, the estimated or predicted usage of the computing device includes a timing of when the computing device 102 is predicted to be connected to a power resource and a predicted duration of the connection of the computing device 102 to the power resource. A value is determine indicating an amount of time until the computing device is predicted to be connected to a power resource, such as a value that is a number of seconds or minutes. Another value is determined indicating a time duration that the computing device 102 is predicted to be connected to a power resource, such as a value that is a number of seconds or minutes. By way of another example, various non-binary values can be used. For example, values indicating how much power can be delivered by the power resource that the computing device is predicted to be connected to can be generated, values indicating how long the computing device is expected to be connected to the power resource can be generated, values indicating how much energy is expected to be drawn from the power resource for the duration that the computing device is connected to the power resource can be generated, and so forth.

The power resource selection module 216 can use these values in various different manners. In one or more embodiments, if the computing device is predicted to be connected to a power resource for a small amount of time in the near future and the amount of charge remaining in the energy storage devices is below a threshold amount, then the power resource selection module 216 selects to thermally condition the computing device to reduce the temperature of the computing device. The power resource selection module 216 can select to thermally condition the computing device if the energy storage device(s) of the computing device is in a thermally hot zone, or alternatively regardless of the current temperature of any thermal zones of the computing device. By thermally conditioning the computing device and reducing the temperature of the computing device, the power resource selection module 216 readies the computing device for the predicted upcoming connection to the power resource. Because the temperature of the computing device has been reduced, the charging of the energy storage device can contribute to a greater rise in the temperature of the computing device while not resulting in the thermal zone that includes the energy storage device being a thermally hot zone.

Various actions can be taken to thermally condition the computing device, such as turning on active cooling mechanisms (e.g., fans), lowering the performance state of the computing device 102 (e.g., reducing the frequency at which a central processing unit runs, disabling a graphics processing unit), and so forth.

The computing device being predicted to be connected to a power resource in the near future refers to the computing device being predicted to be connected to a power resource within some threshold amount of time of the current time. This threshold amount of time can be on the order of minutes or hours, such as 10 minutes or 2 hours.

The computing device being predicted to be connected to a power resource for a small amount of time refers to an amount of amount of time that is less than a threshold amount of time, which can be a fixed amount of time (e.g. 5 minutes) or a percentage (e.g., 25% of an estimated amount of time to fully charge an energy storage device in the computing device in light of its current charge level).

Additionally or alternatively, the power resource selection module 216 can use the value indicating the amount of time until the computing device 102 is predicted to be connected to a power resource and/or the value indicating the time duration that the computing device 102 is predicted to be connected to a power resource in other manners. In one or more embodiments, if the computing device 102 is connected to a power resource but the thermal zone including the energy storage device is thermally hot and the amount of charge remaining in the energy storage devices is predicted to sustain powering the computing device 102 until the computing device 102 is next connected to a power resource, then the power resource selection module 216 determines not to charge the energy storage device. By not charging the energy storage device, the temperature of the thermal zone including the energy storage device is not further increased as a result of charging the energy storage device, thus prioritizing running desired workloads (e.g., executing applications desired by the user of the computing device 102) by the computing device over charging the energy storage device.

However, if the computing device 102 is connected to a power resource and the thermal zone including the energy storage device is thermally hot but the amount of charge remaining in the energy storage devices is not predicted to sustain powering the computing device 102 until the computing device 102 is next connected to a power resource, then the power resource selection module 216 determines to charge the energy storage device. This effectively prioritizes charging the energy storage device over running desired workloads, but is deemed appropriate by the power resource selection module 216 because the amount of charge remaining in the energy storage devices is not predicted to sustain powering the computing device 102 until the computing device 102 is next connected to a power resource.

The prediction module 214 can estimate or predict when the computing device is to be connected to a power resource and a time duration of the connection in a variety of different manners. In one or more embodiments, the prediction module 214 maintains a record (e.g., over a matter of weeks or months) indicating times of the day and/or days of the week that the computing device is connected to a power resource. From this record, the prediction module 214 can identify usage patterns that indicate when the computing device is connected to a power resource and the time durations when the computing device is connected to a power resource. Any of a variety of public and/or proprietary techniques can be used to analyze the record to identify these usage patterns.

For example, if every Sunday (or at least a threshold number of Sundays, such as 80%) from noon to midnight the computing device is connected to a power resource, then the prediction module 214 can predict that on the following Sunday at noon the computing device will be connected to a power resource for 12 hours. By way of another example, if every day of the week (or at least a threshold number of days, such as 75%) from 1:00 pm to 2:30 pm the computing device is connected to a power resource, then if the current time is 12:45 pm, the prediction module 214 can predict that in 15 minutes the computing device will be connected to a power resource for 1 ½ hours.

Additionally or alternatively, the prediction module 214 can when the computing device is to be connected to a power resource and/or a time duration of the connection based on any of a variety of other data. The prediction module 214 can obtain data from various different sources and analyze the data using any of a variety of public and/or proprietary techniques to identify expected future usage patterns.

By way of example, the prediction module 214 can obtain data from a calendar of the user of the computing device 102. The past usage data (the record indicating times of the day and/or days of the week that the computing device connected to a power resource) can be compared to the user's calendar and a determination made that during meetings (or meetings at particular locations) the computing device is connected to a power resource. The prediction module 214 can predict, for example, that the computing device will be connected to a power resource for the duration of upcoming meetings (or meetings at particular locations) identified in the user's calendar.

By way of another example, the prediction module 214 can obtain location data for the computing device 102, such as from a location awareness module of the computing device 102 (e.g., using a global positioning system (GPS), Bluetooth, Wi-Fi, triangulation, etc.). The past usage data (the record indicating times of the day and/or days of the week that the computing device connected to a power resource) can be compared to the user's locations and a determination made that at certain locations (e.g., home) the computing device is connected to a power resource. The prediction module 214 can predict, for example, that the computing device will be connected to a power resource for more than a small amount of time if the user is at home, but that the computing device will be connected to a power resource for a small amount of time if the user is not at home and heading towards work (based on calendar entries, meeting appointments, etc.).

By way of another example, the prediction module 214 can obtain data from a cloud service that collects usage data for computing devices. The cloud service can provide an indication of, for various times of the day and/or days of the week, the duration that users of computing devices of the same type as computing device 102 have their computing devices connected to a power resource. The prediction module 214 can predict, for example, that the computing device 102 will be connected to a power resource for those durations at those times of the day and/or days of the week indicated by the cloud service.

The prediction module 214 can predict whether the amount of charge remaining in the energy storage devices is sufficient to sustain powering the computing device 102 until the computing device 102 is next connected to a power resource in a variety of different manners. In one or more embodiments, the prediction module 214 makes this prediction based on expected future workload and/or power usage of the computing device 102. The expected future workload and/or power usage of the computing device 102 until the computing device 102 is predicted to next be connected to a power resource is determined and is used as a threshold charge amount. A determination is made as to whether there is sufficient charge in the energy storage devices to perform the expected future workload and/or power usage of the computing device 102 (e.g., whether the remaining charge in the energy storage devices is greater than the threshold charge amount).

The prediction module 214 can estimate or predict the expected future workload and/or power usage of the computing device 102 in a variety of different manners. In one or more embodiments, the prediction module 214 maintains a record (e.g., over a matter of weeks or months) indicating times of the day and/or days of the week and the power usage during those times and/or days. From this record, the prediction module 214 can identify usage patterns that indicate power usage of the computing device 102. Any of a variety of public and/or proprietary techniques can be used to analyze the record to identify usage patterns based on time and/or day. Additionally or alternatively, the prediction module 214 maintains a record of applications run on the computing device 102 and the power usage while those applications are run. From this record, the prediction module 214 can identify usage patterns that indicate power usage of the computing device 102 based on application(s) running. Any of a variety of public and/or proprietary techniques can be used to analyze the record to identify usage patterns.

For example, if every Monday (or at least a threshold number of Mondays, such as 80%) from 7:00 am to 10:00 am a particular amount of power (e.g., 1500 milliamp hours (mAh)) is used, then the prediction module 214 can predict that on the following Monday from 7:00 am to 10:00 am the computing device will use that same particular amount of power (e.g., 1500 mAh). By way of another example, if every day of the week (or at least a threshold number of days, such as 75%) from noon to 1:00 pm the computing device uses a particular amount of power (e.g., 30 mAh), then the prediction module 214 can predict that, if it is currently 11:00 am, the computing device will use 30 mAh from noon to 1:00 pm today. By way of yet another example, if every time (or at least a threshold number of times, such as 70%) an image processing application is run on the computing device the computing device uses 1000 milliamps per hour (mA/h), then the prediction module 214 can predict that, if that image processing is currently running on the computing device then the computing device will currently use 1000 mA/h.

Additionally or alternatively, the prediction module 214 can estimate or predict the expected future workload and/or power usage of the computing device 102 based on any of a variety of other data. The prediction module 214 can obtain data from various different sources and analyze the data using any of a variety of public and/or proprietary techniques to identify expected future usage patterns.

By way of example, the prediction module 214 can obtain data from a calendar of the user of the computing device 102. The past usage data (the record indicating times of the day and/or days of the week and the power usage during those times and/or days) can be compared to the user's calendar and a determination made that during meetings (or meetings at particular locations) the computing device uses a particular amount of power (e.g., 50 mA/h). The prediction module 214 can predict, for example, that the computing device will also use 50 mA/h during upcoming meetings (or meetings at particular locations) identified in the user's calendar, or more than 50 mA/h (e.g., 70 mA/h) if the user is marked as meeting presenter.

By way of example, the prediction module 214 can obtain data from a calendar and/or digital personal assistant (e.g., the Cortana® personal assistant) of the user of the computing device 102. The prediction module 214 can predict, given this obtained data, when the user will be away from the computing device 102 (e.g., for a meeting, for coffee, etc.). The prediction module 214 can further predict, for example, that the computing device will use a small amount of power (e.g., 5 mA/h) while the user is away from the computing device 102.

By way of example, the prediction module 214 can obtain location data for the computing device 102, such as from a location awareness module of the computing device 102. The past usage data (the record indicating times of the day and/or days of the week and the power usage during those times and/or days) can be compared to the user's locations and a determination made that at certain locations (e.g., home) the computing device uses a particular amount of power (e.g., 100 mA/h). The prediction module 214 can predict, for example, that the computing device will also use 100 mA/h when the user is next at home.

By way of example, the prediction module 214 can obtain data from a cloud service that collects usage data for computing devices. The cloud service can provide an indication of times of the day and/or days of the week and the power usage during those times and/or days for other computing devices of the same type as computing device 102. The prediction module 214 can predict, for example, that the computing device will use similar or the same amount of power during those times of the day and/or days of the week indicated by the cloud service.

Given the information from the static criteria determination module 210, the dynamic system criteria determination module 212, and/or the prediction module 214, the power resource selection module 216 can readily select which power resources 222, 224 to use to charge which energy storage device(s) 202 at any particular time. The determination of which power resources 222, 224 to use to charge which energy storage device(s) 202 at various times, such as at regular or irregular intervals (e.g., some time duration), in response to certain events (e.g., the computing device 200 being newly connected to a power resource), and so forth.

In one or more embodiments, the power resource selection module 216 uses the individual criteria as discussed above. The energy storage device selection module 216 can use individual criteria or alternatively any combination of criteria. Additionally or alternatively, the power resource selection module 216 can apply various different rules or algorithms to determine which power resources 222, 224 to use to charge which energy storage device(s) 202 at any given time.

In one or more embodiments, the power resource selection module 216 attempts to satisfy all the criteria used by the dynamic external power resource selection system 126. Although various criteria are discussed herein, it should be noted that not all of the criteria discussed herein need by used by the dynamic external power resource selection system 126. Additionally or alternatively, additional criteria can also be used by the dynamic external power resource selection system 126.

If all of the criteria used by the dynamic external power resource selection system 126 can be satisfied, then the power resource selection module 216 selects which power resources 222, 224 to use to charge which energy storage device(s) 202 at any given time so that all the criteria used by the dynamic external power resource selection system 126 are satisfied. However, situations can arise where all of the criteria cannot be satisfied. For example, the most energy efficient charging path to an energy storage device from the power resource may be in a thermally hot zone, so one criteria may indicate to use that power resource but another criteria indicates not to use that power resource.

In one or more embodiments, each criteria is assigned a different classification. Various different classification levels with various different labels can be used, and these classification levels can be assigned statically and/or dynamically. Any of a variety of different classification names or labels can be used. One example of classification levels is (in order of priority or importance) critical, important, and informational. Other classification levels or labels can alternatively be used, such as a number or an “importance” value (e.g., 0 through 100). Higher classification levels are given priority over lower classification levels. For example, assume that proximity of power resources to the energy storage devices is given a classification level of important, and the charging path being in a thermally stable zone is given a classification level of critical (which is higher than important). If the most energy efficient power resource for a particular energy storage device is in a thermally hot zone, then the power resource selection module 216 selects a power resource to charge the particular energy storage device other than the most energy efficient power resource because selecting a charging path in a thermally stable zone is given priority over selecting the most energy efficient power resource.

In one or more embodiments, situations can also arise in which criteria at the same classification level conflict with one another. Such situations can be resolved in various manners, such as by using priority levels assigned to the different criteria. These priority levels can be assigned statically and/or dynamically. Any of a variety of different priority names or labels can be used. One example of labels is (in order of priority or importance) high, medium, and low. If two different criteria having the same classification level conflict (e.g., one criteria indicates that a particular energy storage device should be used and another indicates that particular energy storage device should not be used), then the power resource selection module 216 applies the criteria having the higher priority. However, if two different criteria having the same priority level but different classification levels conflict, then the power resource selection module 216 applies the criteria having the higher classification level.

The evaluation of classifications levels and priority levels can alternatively be performed in the reverse order. For example, if two different criteria conflict (e.g., one criteria indicates that a particular energy storage device should be used and another indicates that particular energy storage device should not be used), then the energy storage device selection module 216 applies the criteria having the higher priority. Situations can arise in which criteria at the same priority level conflict with one another. Such situations can be resolved in various manners, such as by using classification levels assigned to the different criteria. E.g., if two different criteria having the same priority level conflict (e.g., one criteria indicates that a particular energy storage device should be used and another indicates that particular energy storage device should not be used), then the energy storage device selection module 216 applies the criteria having the higher classification level.

The techniques discussed herein provide a dynamic approach to selecting which of multiple power resources to use to charge energy storage devices. This dynamic approach varies based on multiple different criteria, and can factor in the way in which a user uses his or her computing device. Thus, rather than having a one-size-fits-all approach to selecting a power resource to charge an energy storage device, the dynamic approach discussed herein is customized or tailored to the individual user. This results in improved performance and improved thermal stability of the computing device.

It should be noted that although various different values, labels, levels, and so forth are discussed herein, these are examples and the techniques discussed herein are not limited to these examples. For example, any specific threshold values and/or labels discussed herein are only examples, and various other threshold values and/or labels can additionally or alternatively be used. These examples are illustrations only and are not intended to limit the scope of the techniques discussed herein.

### Example Procedures

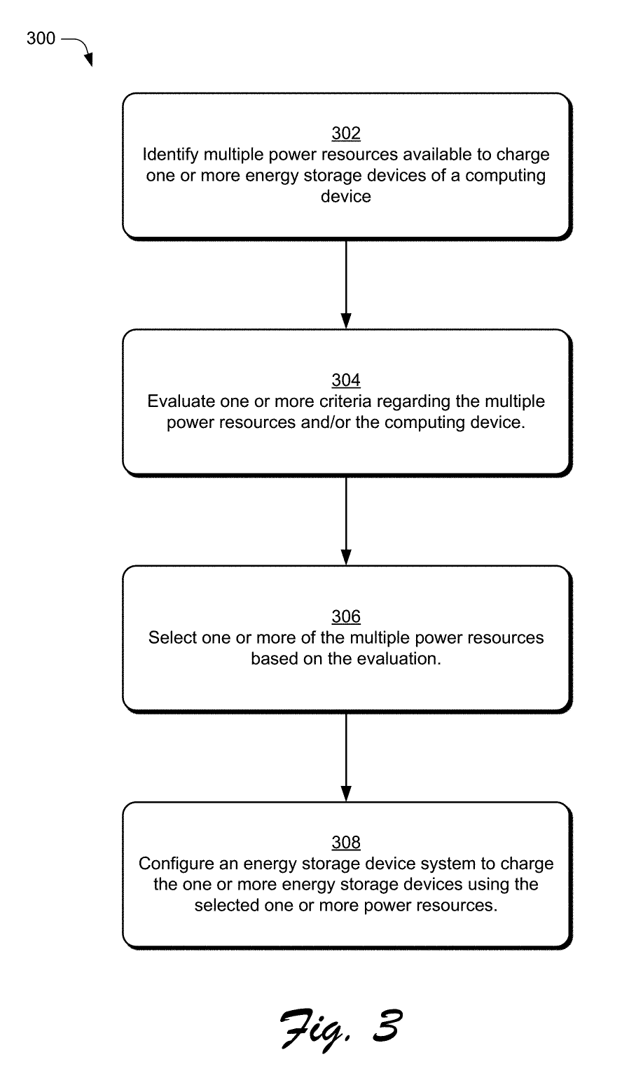

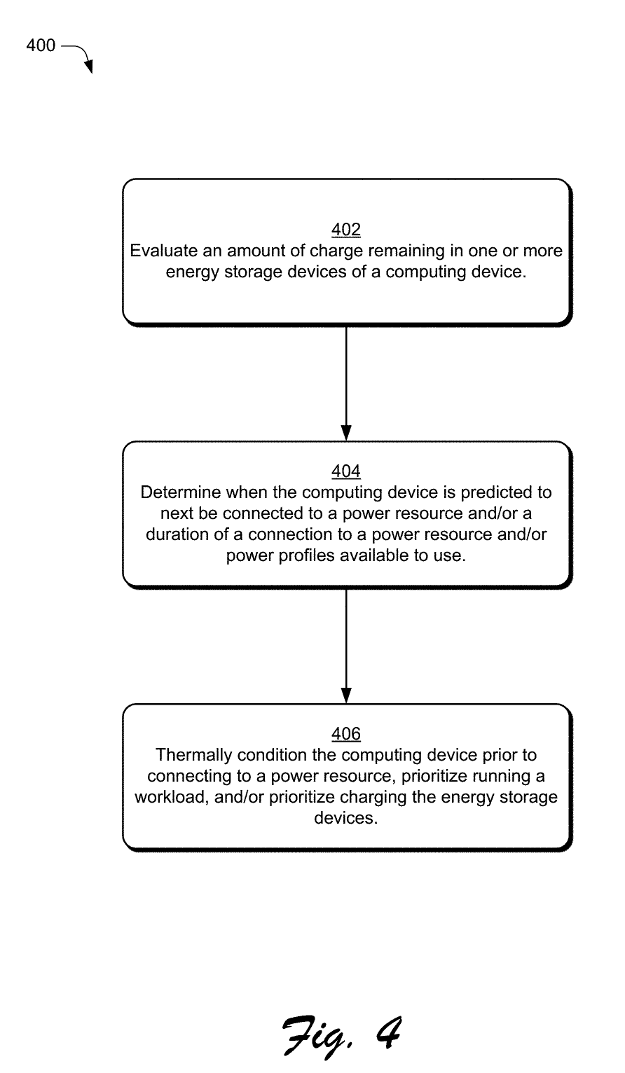

Further aspects of the dynamic external power resource selection techniques are discussed in relation to example procedures of FIGS. 3 and 4. The procedures described in this document may be implemented utilizing the environment, system, devices, and components described herein and in connection with any suitable hardware, software, firmware, or combination thereof. The procedures may be represented as a set of blocks that specify operations performed by one or more entities and are not necessarily limited to the orders shown for performing the operations by the respective blocks.

FIG. 3 is a flow diagram that describes details of an example procedure 300 for dynamic external power resource selection in accordance with one or more implementations. The procedure 300 describes details of selecting a power resource. The procedure 300 can be implemented by way of a suitably configured computing device, such as by way of an operating system 108, dynamic external power resource selection system 126, and/or other functionality described in relation to the examples of FIGS. 1-2.

Multiple power resources available to charge one or more energy storage devices of computing device are identified (block 302). Which power resources are connected to the computing device, whether wired or wirelessly, can vary over time. When connected, the connection can be readily identified based on the protocol or standard used by the power resource.

One or more criteria regarding the multiple power resources and/or the computing device are evaluated (block 304). Various criteria can be evaluated as described above. For example, thermal activity along a charging path from the power resources to the energy storage device can be evaluated, the electrical proximity of the power resources to the energy storage device can be evaluated, and so forth. Additionally, user convenience may be factored in, such as it may be sub optimal to use a wireless charging source, but it is more convenient to the user to use a wireless charging source because it requires less work on user's part, and so forth.

One or more of the multiple power resources are selected based on the evaluation (block 306). The selected power resource is, for example, the power resource that is most energy efficient for the energy storage device to which power is to be provided. An energy storage device system is configured to charge the one or more energy storage devices using the selected one or more power resources (block 308). This configuration routes power to the one or more energy storage devices, charging the one or more energy storage devices.

FIG. 4 is a flow diagram that describes details of an example procedure 400 for dynamic external power resource selection in accordance with one or more implementations. The procedure 400 describes details of selecting a power resource. The procedure 400 can be implemented by way of a suitably configured computing device, such as by way of an operating system 108, dynamic external power resource selection system 126, and/or other functionality described in relation to the examples of FIGS. 1-2.

An amount of charge remaining in one or more energy storage devices of a computing device is evaluated (block 402). This evaluation can include determining an amount of charge remaining in the one or more energy storage devices can be made in various manners, such as querying the energy storage device or the energy storage device controller.

When the computing device is predicted to next be connected to a power resource and/or a duration of the connection to a power resource and/or power profiles available to use is determined (block 404). Various different data can be analyzed to determine these prediction(s) and/or available power profiles as discussed above. Any one or any combination of these predictions(s) and/or power profile availabilities can be determined in act 404.

Based on the determination in block 404, the computing device is thermally conditioned prior to connecting the computing device to a power resource, running a workload (e.g., a performance intensive workload) is prioritized, and/or charging the energy storage device is prioritized (block 406). Various different actions can be taken in block 406 based on various different factors, such as whether the energy storage device is thermally hot, whether the amount of charge remaining in the energy storage devices is predicted to sustain powering the computing device until the computing device is next connected to a power resource, and so forth.

### Example System

FIG. 5 illustrates an example system 500 that includes an example computing device 502 that is representative of one or more computing systems and/or devices that may implement the various techniques described herein. The computing device 502 may be, for example, a server of a service provider, a device associated with a client (e.g., a client device), an on-chip system, and/or any other suitable computing device or computing system.

The example computing device 502 as illustrated includes a processing system 504, one or more computer-readable media 506, and one or more I/O interfaces 508 that are communicatively coupled, one to another. Although not shown, the computing device 502 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 504 is representative of functionality to perform one or more operations using hardware. Accordingly, the processing system 504 is illustrated as including hardware elements 510 that may be configured as processors, functional blocks, and so forth. This may include implementation in hardware as an application specific integrated circuit or other logic device formed using one or more semiconductors. The hardware elements 510 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable media 506 is illustrated as including memory/storage 512. The memory/storage 512 represents memory/storage capacity associated with one or more computer-readable media. The memory/storage 512 may include volatile media (such as random access memory (RAM)) and/or nonvolatile media (such as read only memory (ROM), Flash memory, optical disks, magnetic disks, and so forth). The memory/storage 512 may include fixed media (e.g., RAM, ROM, a fixed hard drive, and so on) as well as removable media (e.g., Flash memory, a removable hard drive, an optical disc, and so forth). The computer-readable media 506 may be configured in a variety of other ways as further described below.

Input/output interface(s) 508 are representative of functionality to allow a user to enter commands and information to computing device 502, and also allow information to be presented to the user and/or other components or devices using various input/output devices. Examples of input devices include a keyboard, a cursor control device (e.g., a mouse), a microphone for voice operations, a scanner, touch functionality (e.g., capacitive or other sensors that are configured to detect physical touch), a camera (e.g., which may employ visible or non-visible wavelengths such as infrared frequencies to detect movement that does not involve touch as gestures), and so forth. Examples of output devices include a display device (e.g., a monitor or projector), speakers, a printer, a network card, tactile-response device, and so forth. Thus, the computing device 502 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 502. By way of example, and not limitation, computer-readable media may include “computer-readable storage media” and “communication media.”

“Computer-readable storage media” refers to media and/or devices that enable storage of information in contrast to mere signal transmission, carrier waves, or signals per se. Computer-readable storage media does not include signal bearing media, transitory signals, or signals per se. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Communication media” may refer to signal-bearing media that is configured to transmit instructions to the hardware of the computing device 502, such as via a network. Communication media typically may embody computer readable instructions, data structures, program modules, or other data in a modulated data signal, such as carrier waves, data signals, or other transport mechanism. Communication media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 510 and computer-readable media 506 are representative of instructions, modules, programmable device logic and/or fixed device logic implemented in a hardware form that may be employed in some embodiments to implement at least some aspects of the techniques described herein. Hardware elements may include components of an integrated circuit or on-chip system, an application-specific integrated circuit (ASIC), a field-programmable gate array (FPGA), a complex programmable logic device (CPLD), and other implementations in silicon or other hardware devices. In this context, a hardware element may operate as a processing device that performs program tasks defined by instructions, modules, and/or logic embodied by the hardware element as well as a hardware device utilized to store instructions for execution, e.g., the computer-readable storage media described previously.

Combinations of the foregoing may also be employed to implement various techniques and modules described herein. Accordingly, software, hardware, or program modules including the operating system 108, applications 110, dynamic external power resource selection system 126, and other program modules may be implemented as one or more instructions and/or logic embodied on some form of computer-readable storage media and/or by one or more hardware elements 510. The computing device 502 may be configured to implement particular instructions and/or functions corresponding to the software and/or hardware modules. Accordingly, implementation of modules as a module that is executable by the computing device 502 as software may be achieved at least partially in hardware, e.g., through use of computer-readable storage media and/or hardware elements 510 of the processing system. The instructions and/or functions may be executable/operable by one or more articles of manufacture (for example, one or more computing devices 502 and/or processing systems 504) to implement techniques, modules, and examples described herein.

As further illustrated in FIG. 5, the example system 500 enables ubiquitous environments for a seamless user experience when running applications on a personal computer (PC), a television device, and/or a mobile device. Services and applications run substantially similar in all three environments for a common user experience when transitioning from one device to the next while utilizing an application, playing a video game, watching a video, and so on.

In the example system 500, multiple devices are interconnected through a central computing device. The central computing device may be local to the multiple devices or may be located remotely from the multiple devices. In one embodiment, the central computing device may be a cloud of one or more server computers that are connected to the multiple devices through a network, the Internet, or other data communication link.

In one embodiment, this interconnection architecture enables functionality to be delivered across multiple devices to provide a common and seamless experience to a user of the multiple devices. Each of the multiple devices may have different physical requirements and capabilities, and the central computing device uses a platform to enable the delivery of an experience to the device that is both tailored to the device and yet common to all devices. In one embodiment, a class of target devices is created and experiences are tailored to the generic class of devices. A class of devices may be defined by physical features, types of usage, or other common characteristics of the devices.

In various implementations, the computing device 502 may assume a variety of different configurations, such as for computer 514, mobile 516, and television 518 uses. Each of these configurations includes devices that may have generally different constructs and capabilities, and thus the computing device 502 may be configured according to one or more of the different device classes. For instance, the computing device 502 may be implemented as the computer 514 class of a device that includes a personal computer, desktop computer, a multi-screen computer, laptop computer, netbook, and so on.

The computing device 502 may also be implemented as the mobile 516 class of device that includes mobile devices, such as a mobile phone, portable music player, portable gaming device, a tablet computer, a multi-screen computer, and so on. The computing device 502 may also be implemented as the television 518 class of device that includes devices having or connected to generally larger screens in casual viewing environments. These devices include televisions, set-top boxes, gaming consoles, and so on.

The techniques described herein may be supported by these various configurations of the computing device 502 and are not limited to the specific examples of the techniques described herein. This is illustrated through inclusion of the dynamic external power resource selection system 126 and the energy storage device system 128 on the computing device 502. The functionality represented by dynamic external power resource selection system 126 and other modules/applications may also be implemented all or in part through use of a distributed system, such as over a “cloud” 520 via a platform 522 as described below.

The cloud 520 includes and/or is representative of a platform 522 for resources 524. The platform 522 abstracts underlying functionality of hardware (e.g., servers) and software resources of the cloud 520. The resources 524 may include applications and/or data that can be utilized while computer processing is executed on servers that are remote from the computing device 502. Resources 524 can also include services provided over the Internet and/or through a subscriber network, such as a cellular or Wi-Fi network.

The platform 522 may abstract resources and functions to connect the computing device 502 with other computing devices. The platform 522 may also serve to abstract scaling of resources to provide a corresponding level of scale to encountered demand for the resources 524 that are implemented via the platform 522. Accordingly, in an interconnected device embodiment, implementation of functionality described herein may be distributed throughout the system 500. For example, the functionality may be implemented in part on the computing device 502 as well as via the platform 522 that abstracts the functionality of the cloud 520.

In the discussions herein, various different embodiments are described. It is to be appreciated and understood that each embodiment described herein can be used on its own or in connection with one or more other embodiments described herein. Further aspects of the techniques discussed herein relate to one or more of the following embodiments.

A method implemented in a computing device having an energy storage device system including one or more energy storage devices, the method comprising: identifying multiple power resources available to the computing device to charge a first energy storage device of the one or more energy storage devices; selecting a first power resource of the multiple power resources that is most energy efficient for the first energy storage device; and configuring the energy storage device system to charge the first energy storage device using the first power resource.

Alternatively or in addition to any of the above described methods, any one or combination of: each of the multiple power resources comprising a different power source; each of the multiple power resources comprising one of multiple power profiles of a power source; wherein the selecting comprises identifying, for each of the multiple power resources, an interconnect resistance between the power resource and the first energy storage device, and selecting as the first power resource one of the multiple power resources having a smallest interconnect resistance between the power resource and the first energy storage device; wherein the one or more energy storage devices include multiple energy storage devices, the method further comprising selecting a second power resource of the multiple power resources that is most energy efficient for a second energy storage device of the multiple energy storage devices, and configuring the energy storage device system to charge the second energy storage device using the second power resource concurrently with charging the first energy storage device using the first power resource; the method further comprising, when the computing device is no longer connected to a power resource determining that an amount of charge in the one or more energy storage devices is below a threshold amount of charge, determining that the computing device is predicted to be connected to a power resource for less than a threshold amount of time, and thermally conditioning the computing device, prior to the computing device being connected to the power resource, to reduce a temperature of the computing device; the method further comprising stopping charging the first energy storage device in response to the computing device being in a high performance state; the method further comprising resuming charging the first energy storage device in response to the computing device being in a low performance state.

A method implemented in a computing device having an energy storage device system including one or more energy storage devices, the method comprising: identifying multiple power resources available to the computing device to charge a first energy storage device of the one or more energy storage devices; determining, for each of the multiple power resources, thermal activity along a charging path from the power resource to the first energy storage device; selecting a power resource of the multiple power resources based on the thermal activity along the charging paths from the multiple power resources to the first energy storage device; and configuring the energy storage device system to charge the first energy storage device using the selected power source.

Alternatively or in addition to any of the above described methods, any one or combination of: the selecting comprising selecting as the power resource one of the multiple power resources having a charging path to the first energy storage device that is in a thermally stable zone; the selecting and configuring comprising duty cycling the multiple power resources; the method further comprising stopping charging the first energy storage device in response to the computing device being in a high performance state; the method further comprising resuming charging the first energy storage device in response to the computing device being in a low performance state; each of the multiple power resources comprising a different power source; each of the multiple power resources comprising one of multiple power profiles of a power source.

A computing device comprising: an energy storage device system including one or more energy storage devices; a processing system; a computer-readable storage medium having stored thereon multiple instructions that, responsive to execution by the processing system, cause the one or more processors to perform operations comprising: determining that an amount of charge in the one or more energy storage devices is below a threshold amount of charge; determining that the computing device is predicted to be connected to a power resource for less than a threshold amount of time; thermally conditioning the computing device, prior to the computing device being connected to the power resource, to reduce a temperature of the computing device.

Alternatively or in addition to any of the above described computing devices, any one or combination of: the operations further comprising determining, while the computing device is subsequently connected to a power resource, to not charge the one or more energy storage devices in response to the one or more energy storage devices being in a thermally hot zone and an amount of charge remaining in the one or more energy storage devices being predicted to sustain powering the computing device until the computing device is next connected to a power resource; the operations further comprising determining, while the computing device is subsequently connected to a power resource, to charge the one or more energy storage devices in response to an amount of charge remaining in the one or more energy storage devices being predicted to not sustain powering the computing device until the computing device is next connected to a power resource; the threshold amount of charge comprising expected power usage of the computing device until the computing device is predicted to next be connected to a power resource; the thermally conditioning comprising thermally conditioning the computing device only if at least one of the energy storage devices is in a thermally hot zone.

### CONCLUSION

Although the example implementations have been described in language specific to structural features and/or methodological acts, it is to be understood that the implementations defined in the appended claims are not necessarily limited to the specific features or acts described. Rather, the specific features and acts are disclosed as example forms of implementing the claimed features.

What is claimed is:

1. A method implemented in a computing device having an energy storage device system including one or more energy storage devices, the method comprising:
identifying multiple power resources available to the computing device to charge a first energy storage device of the one or more energy storage devices;
selecting a first power resource of the multiple power resources that is most energy efficient for the first energy storage device; and
configuring the energy storage device system to charge the first energy storage device using the first power resource.

2. The method as recited in claim 1, each of the multiple power resources comprising a different power source.

3. The method as recited in claim 1, each of the multiple power resources comprising one of multiple power profiles of a power source.

4. The method as recited in claim 1, wherein the selecting comprises:
identifying, for each of the multiple power resources, an interconnect resistance between the power resource and the first energy storage device;
selecting as the first power resource one of the multiple power resources having a smallest interconnect resistance between the power resource and the first energy storage device.

5. The method as recited in claim 1, wherein the one or more energy storage devices include multiple energy storage devices, the method further comprising:
selecting a second power resource of the multiple power resources that is most energy efficient for a second energy storage device of the multiple energy storage devices;
configuring the energy storage device system to charge the second energy storage device using the second power resource concurrently with charging the first energy storage device using the first power resource.

6. The method as recited in claim 1, the method further comprising, when the computing device is no longer connected to a power resource:
determining that an amount of charge in the one or more energy storage devices is below a threshold amount of charge;
determining that the computing device is predicted to be connected to a power resource for less than a threshold amount of time;
thermally conditioning the computing device, prior to the computing device being connected to the power resource, to reduce a temperature of the computing device.

7. The method as recited in claim 1, further comprising stopping charging the first energy storage device in response to the computing device being in a high performance state.

8. The method as recited in claim 7, further comprising resuming charging the first energy storage device in response to the computing device being in a low performance state.

9. A method implemented in a computing device having an energy storage device system including one or more energy storage devices, the method comprising:
identifying multiple power resources available to the computing device to charge a first energy storage device of the one or more energy storage devices;
determining, for each of the multiple power resources, thermal activity along a charging path from the power resource to the first energy storage device;
selecting a power resource of the multiple power resources based on the thermal activity along the charging paths from the multiple power resources to the first energy storage device; and
configuring the energy storage device system to charge the first energy storage device using the selected power source.

10. The method as recited in claim 9, the selecting comprising selecting as the power resource one of the multiple power resources having a charging path to the first energy storage device that is in a thermally stable zone.

11. The method as recited in claim 9, the selecting and configuring comprising duty cycling the multiple power resources.

12. The method as recited in claim 9, further comprising stopping charging the first energy storage device in response to the computing device being in a high performance state.

13. The method as recited in claim 12, further comprising resuming charging the first energy storage device in response to the computing device being in a low performance state.

14. The method as recited in claim 9, each of the multiple power resources comprising a different power source.

15. The method as recited in claim 9, each of the multiple power resources comprising one of multiple power profiles of a power source.

16. A computing device comprising:
an energy storage device system including one or more energy storage devices;
a processing system;
a computer-readable storage medium having stored thereon multiple instructions that, responsive to execution by the processing system, cause the one or more processors to perform operations comprising:
determining that an amount of charge in the one or more energy storage devices is below a threshold amount of charge;
determining that the computing device is predicted to be connected to a power resource for less than a threshold amount of time;
thermally conditioning the computing device, prior to the computing device being connected to the power resource, to reduce a temperature of the computing device.

17. The computing device as recited in claim 16, the operations further comprising determining, while the computing device is subsequently connected to a power resource, to not charge the one or more energy storage devices in response to the one or more energy storage devices being in a thermally hot zone and an amount of charge remaining in the one or more energy storage devices being predicted to sustain powering the computing device until the computing device is next connected to a power resource.

18. The computing device as recited in claim 16, the operations further comprising determining, while the computing device is subsequently connected to a power resource, to charge the one or more energy storage devices in response to an amount of charge remaining in the one or more energy storage devices being predicted to not sustain powering the computing device until the computing device is next connected to a power resource.

19. The computing device as recited in claim 16, the threshold amount of charge comprising expected power usage of the computing device until the computing device is predicted to next be connected to a power resource.

20. The computing device as recited in claim 16, the thermally conditioning comprising thermally conditioning the computing device only if at least one of the energy storage devices is in a thermally hot zone.
